(19) United States
(12) Patent Application Publication
(10) Pub. No.: US 2016/0294055 A1
(43) Pub. Date: Oct. 6, 2016

(54) TRANSFER-FUNCTION COPYING CIRCUIT AND GANG-CONTROLLED PHASE DISPLACEMENT CIRCUIT

(71) Applicant: MARCDEVICES CO., LTD., Hiratsuka-shi, Kanagawa (JP)

(72) Inventor: Koichi HIRAMA, Hiratsuka-shi, Kanagawa (JP)

(21) Appl. No.: 15/034,818

(22) PCT Filed: Nov. 5, 2013
(86) PCT No.: PCT/JP2013/079859

§ 371 Date: May 5, 2016

(51) Int. Cl. H01Q 3/34

(52) U.S. Cl. CPC H01Q 3/34

(57) ABSTRACT

The present invention comprises: a reference-signal generation circuit 5 that performs a reference-signal generation process on a first input signal and outputs a resulting first reference signal and a resulting second reference signal proportional to the first input signal; a coefficient-signal synthesis circuit 6 that performs a coefficient-signal synthesis process on the first reference signal and a second input signal containing at least a frequency component contained in the first input signal, and outputs a resulting coefficient signal; a transfer-signal production circuit 7 that performs a desired frequency-selection control process on the second reference signal and outputs a resulting transfer signal; and a transfer-signal synthesis circuit 9 that performs a transfer-signal synthesis process on the coefficient signal and the transfer signal and outputs a resulting signal to an output terminal.

### TECHNICAL FIELD

The present invention relates to an electronic circuit element and to a transfer-function copying circuit and a gang-controlled phase displacement circuit that copy the transfer characteristic of a single reference circuit to a plurality of other circuits as an equivalent transfer characteristic.

### BACKGROUND ART

There are cases where an electronic circuit needs a plurality of “similar circuits,” i.e. a plurality of “circuits that have the same total number of poles and zeros including cases where poles and zeros switch.” There has been known a beam forming technique that two- or three-dimensionally controls the directions of beams of radio waves transmitted from a plurality of antennas, by providing a plurality of phase displacement circuits respectively for the plurality of antennas between the plurality of antennas and a single transmitter, the plurality of phase displacement circuits being configured to generate amounts of phase displacement that have given relationships with each other.

The plurality of phase displacement circuits mentioned above are formed by providing a series of similar circuits having circuit constants that have given relationships with each other. This series of similar circuits is circuits including reactance elements.

Meanwhile, a phased array antenna described in Patent Document 1 has been known as a conventional technique of this type.

### PRIOR ART DOCUMENT

### Patent Document

Patent Document 1: Japanese Patent Application Publication No. 2013-9247

### SUMMARY OF THE INVENTION

### Problems to be Solved by the Invention

However, to make the beam forming directions variable, there is a difficulty in gang-controlling the circuit constants of the circuits. Also, a series of reactance elements such as coils included in the reactance circuits need to be provided. Thus, external components increase and downsizing by LSI is therefore difficult.

The present invention aims to provide a transfer-function copying circuit and a gang-controlled phase displacement circuit capable of reducing the number of reactance elements and reducing external components for LSI.

### Means for Solving the Problems

A transfer-function copying circuit of the present invention for solving the above problems comprises: a reference-signal generation circuit that performs a reference-signal generation process on a first input signal and outputs a resulting first reference signal and a resulting second reference signal proportional to the first input signal; a coefficient-signal synthesis circuit that performs a coefficient-signal synthesis process on the first reference signal and a second input signal containing at least a frequency component contained in the first input signal, and outputs a resulting coefficient signal; a transfer-signal production circuit that performs a desired frequency-selection control process on the second reference signal and outputs a resulting transfer signal; and a transfer-signal synthesis circuit that performs a transfer-signal synthesis process on the coefficient signal and the transfer signal and outputs a resulting signal to an output terminal.

Also, a gang-controlled phase displacement circuit comprises a variable-radiation-direction antenna circuit including a plurality of antennas, a plurality of phase displacement circuits provided respectively for the plurality of antennas, and a coupling circuit coupling the plurality of antennas and the plurality of phase displacement circuits to any one of a transmission circuit, a reception circuit, and a transmission-reception circuit, wherein each of the plurality of phase displacement circuits includes the transfer-function copying circuit, and the second input terminal and the output terminal of the transfer-function copying circuit and a variable amplification-attenuation circuit including an amplification-attenuation-gain control terminal, on a current path including any two of an input terminal, an output terminal, and a reference terminal of the phase displacement circuit.

### Effects of the Invention

A transfer characteristic proportional to a transfer function produced by a single transfer-signal production circuit is distributed and copied to a plurality of copy destination circuits. In this way, the number of reactance elements can be reduced, and external components for LSI can be reduced.

### BRIEF DESCRIPTION OF THE DRAWINGS

FIG. 1 is a diagram showing the configuration of a transfer-function copying circuit in Embodiment 1.

FIG. 2 is a diagram showing the configuration of a transfer-function copying circuit in Embodiment 2.

FIG. 3 is a diagram showing the configuration of a transfer-function copying circuit in Embodiment 3.

FIG. 4 is a diagram showing the configuration of a transfer-function copying circuit in Embodiment 4.

FIG. 5 is a graph showing the results of numerical simulations on the circuit configuration shown in FIG. 4.

FIG. 6 is a diagram showing the configuration of a transfer-function copying circuit in Embodiment 5.

FIG. 7 is a graph showing the results of numerical simulations on the circuit configuration shown in FIG. 6.

FIG. 8 is a diagram showing the configuration of a distribution-type transfer-function copying circuit in Embodiment 6.

FIG. 9 is a diagram showing the configuration of a gang-controlled phase displacement circuit in Embodiment 7.

FIG. 10 is a graph showing the results of simulations on the gang-controlled phase displacement circuit, which is shown in FIG. 9.

### MODES FOR CARRYING OUT THE INVENTION

### Embodiment 1

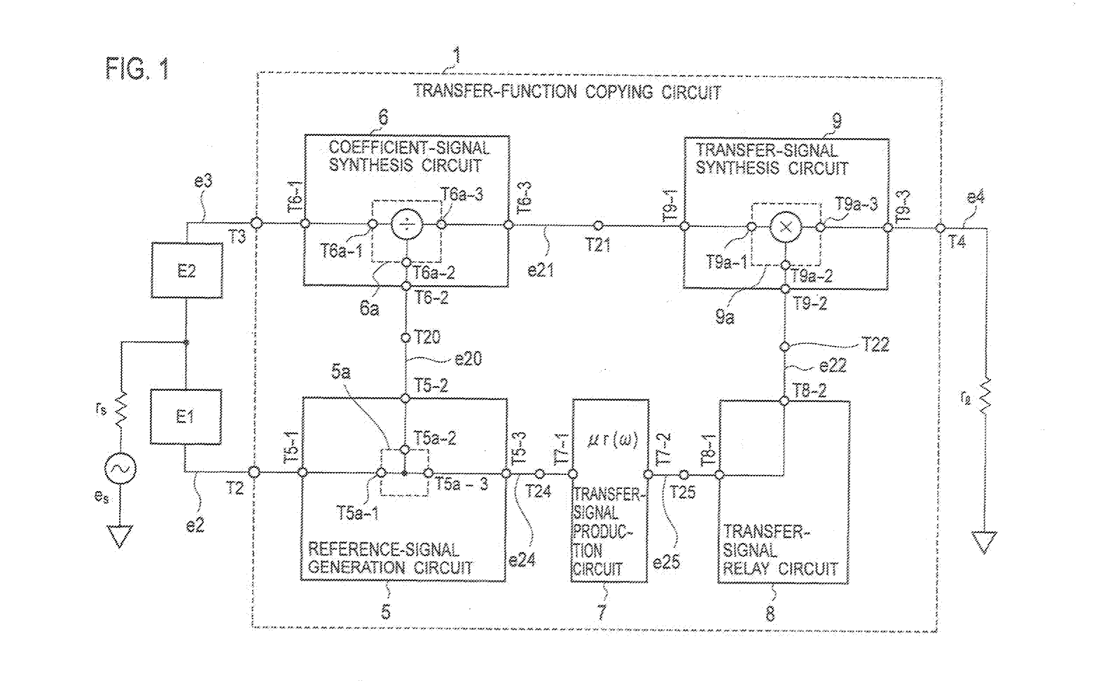

FIG. 1 is a diagram showing the configuration of a transfer-function copying circuit in Embodiment 1. The transfer-function copying circuit in Embodiment 1 is characterized in that a transfer signal proportional to a transfer function produced by a single transfer-signal production circuit is distributed and copied to a plurality of copy destinations circuits to thereby reduce the number of external components such as reactance elements.

A transfer-function copying circuit 1 shown in FIG. 1 includes: a first input terminal T2 for inputting a first input signal e2; a second input terminal T3 for inputting a second input signal e3 containing at least a frequency component contained in the first input signal e2 fed to the first input terminal T2; and an output terminal T4 for outputting an output signal e4.

The transfer-function copying circuit 1 further includes a reference-signal generation circuit 5, a coefficient-signal synthesis circuit 6, a transfer-signal production circuit 7, a transfer-signal relay circuit 8, and a transfer-signal synthesis circuit 9.

The reference-signal generation circuit 5 performs a reference-signal generation process on the first input signal e2 (signal e5-1) fed from the first input terminal T2 to a terminal T5-1, outputs a first reference signal e20 (signal e5-2) from a terminal T5-2 to a first-reference-signal terminal T20, and outputs a second reference signal e24 (signal e5-3) proportional to the first input signal e2 from a terminal T5-3 to a second-reference-signal terminal T24.

The coefficient-signal synthesis circuit 6 performs a division process (coefficient-signal production process) to divide the second input signal e3 (signal e6-1) fed from the second input terminal T3 to a terminal T6-1 by the first reference signal e20 fed from the terminal T20, and outputs a resulting coefficient signal e21 (signal e6-3) from a terminal T6-3 to a coefficient signal terminal T21.

The transfer-signal production circuit 7 performs a transfer signal process with a transfer function μr(ω) on the second reference signal e24 (signal e7-1) fed from the second-reference-signal terminal T24 to a terminal T7-1, and outputs a resulting transfer signal e25 (signal e7-2) from an output terminal T7-2 to a transfer signal terminal T25. The transfer-signal production circuit 7 is also called an origin circuit or conversion target circuit.

The transfer-signal relay circuit. 8 performs a transfer-signal relay process on the transfer signal e25 (signal e8-1) fed from the transfer signal terminal T25 to a terminal T8-1, and outputs a resulting relayed signal e22 (signal e8-2) from a terminal T8-2 to a relayed signal terminal 122.

The transfer-signal synthesis circuit 9 performs a transfer-signal synthesis process on the coefficient signal e21 (signal e9-1) fed from the coefficient signal terminal T21 to a terminal T9-1 and the relayed signal e22 (signal e9-2) fed from the relayed signal terminal T22 to a terminal T9-2, and outputs a resulting copied signal e4 (signal e9-3) from a terminal T9-3 to the output terminal T4.

More specifically, the reference-signal generation circuit 5 includes a signal distribution circuit 5a that performs a signal distribution process on the signal e2 (signal e5a-l) fed from the terminal T2 to a terminal T5a-1, to distribute and output the first reference signal e20 (signal e5a-2) and the second reference signal e24 (signal e5a-3) from a terminal T5a-2 and a terminal T5a-3 to the terminal T20 and the terminal T24, respectively.

The coefficient-signal synthesis circuit 6 includes a division circuit 6a that performs a division process to divide the signal e3 (signal e6a-1) fed from the terminal T3 to a terminal T6a-1 by the signal e20 (signal e6a-2) fed from the terminal T20 to a terminal T6a-2, and outputs the resulting signal e21 (signal e6a-3) from a terminal T6a-3 to the terminal T21.

The transfer-signal production circuit 7 is a circuit that has a transfer function μr(ω) given optionally and performs a signal transfer process with the transfer function μr(ω) on the signal e24 fed from the terminal T24 to the terminal T7-1, and outputs the resulting signal e25 from the terminal T7-2 to the terminal T25.

The transfer-signal relay circuit 8 outputs the signal e25 fed from the terminal T25 to the terminal T8-1, to the terminal T22 from the terminal T8-2. In other words, in this case, the input terminal T8-1 and the output terminal T8-2 of the transfer-signal relay circuit 8 are formed by a direct-coupled circuit.

The transfer signal synthesis circuit 9 performs a multiplication process on the signal e21 fed from the terminal T21 to a terminal T9a-1 and the signal e22 fed from the terminal T22 to a terminal T9a-2, and outputs the resulting signal e4 from a terminal T9a-3 to the output terminal T4.

Note that an external circuit E1 and an external circuit E2 shown in FIG. 1, which are connected between the terminal T2 and a signal source es and between the terminal T3 and the signal source es, respectively, are circuits given optionally.

Next, the operation of the transfer-function copying circuit 1 according to Embodiment 1 with the above configuration will be described with reference to FIG. 1.

The division circuit 6a performs a division process to divide the signal e3 fed to the terminal T6a-1 by the signal e2 (signal e20) fed from the terminal T20 to the terminal T6a-2. Hence, the resulting signal e21 is equal to e3/e2.

Also, the signal e25 is dependent on the transfer function μr of the transfer-signal production circuit 7 and is equal to the product of the transfer function μr and the signal e2. Then, the relation between the signal e3 and the signal e4 can be expressed by the following formula.

e₄=μᵣ(ω)·e₃ (1)

The ratio of the signal e4 (copied signal e4) to the signal e3 in Mathematical Formula (1) indicates that an equivalent transfer function is equal to the transfer function μr(ω) of the transfer-signal production circuit 7. This phenomenon can be considered that the transfer function μr(ω) is copied.

Thus, with the transfer-function copying circuit 1 in Embodiment 1, the number of external components such as reactance elements can be reduced by distributing and copying a transfer signal proportional to a transfer function produced by a single transfer-signal production circuit 7, to a plurality of copy destination circuits.

### Embodiment 2

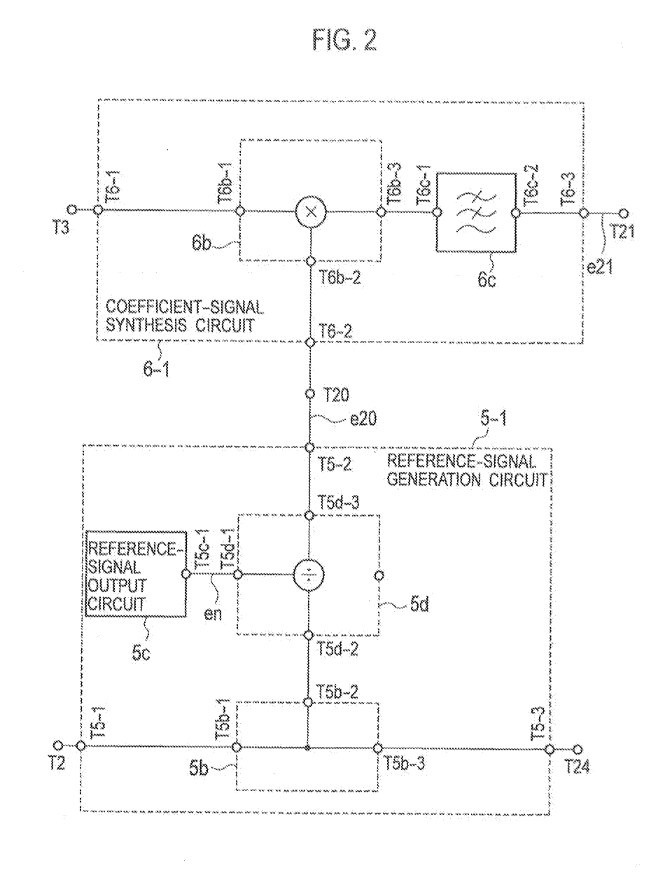

FIG. 2 is a diagram showing the configuration of a transfer-function copying circuit in Embodiment 2. A transfer-function copying circuit 1 in Embodiment 2 is characterized in that the width of the dynamic range of the division circuit in Embodiment 1, or the division circuit 6a, is narrowed.

In doing so, a reference-signal generation circuit 5-1 in Embodiment 2 is provided with a division circuit 5d that performs a reciprocal process, instead of the signal distribution circuit 5a, which is shown in FIG. 1. Also, a coefficient-signal synthesis circuit 6-1 is provided with a multiplication circuit 6b and a low-pass filter circuit 6c instead of the division circuit 6a.

The transfer-function copying circuit shown in FIG. 2 has the same configuration as the transfer-function copying circuit 1 shown in FIG. 1, except the reference-signal generation circuit 5-1 and the coefficient-signal synthesis circuit 6-1. The following will describe only the reference-signal generation circuit 5-1 and the signal-coefficient synthesis circuit 6-1.

The reference-signal generation circuit 5-1 includes a signal distribution circuit 5b, a reference-signal output circuit 5c, and the division circuit 5d. The signal distribution circuit 5b performs a signal distribution process on a signal e5b-1 fed from a terminal T5-1 to a terminal T5b-1 to distribute and output a signal e5b-2 and a signal e5b-3 (signal e24) from a terminal T5b-2 and a terminal T5b-3 to a terminal T5d-2 and a terminal T24, respectively, the signal e5b-3 (signal e24) being outputted to the terminal T24 through a terminal T5-3.

The reference-signal output circuit 5c generates a reference amplitude signal en and outputs it from a terminal T5c-1 to a terminal T5d-1. The division circuit 5d performs a division process to divide the signal en, which is fed from the terminal T5c-1 to the terminal T5d-1, by the signal e5b-2, which is fed from the terminal T5b-2 to the terminal T5d-2, and outputs a resulting signal e5d-3 (signal e20) from a terminal T5d-3 to a terminal T20 through a terminal T5-2.

The coefficient-signal synthesis circuit 6-1 includes the multiplication circuit 6b and the lowpass filter circuit 6c. The multiplication circuit 6b performs a multiplication process on a signal e6-1 (signal e3) fed from a terminal T6-1 to a terminal T6b-1 and the signal e20 fed from the terminal T20 to a terminal T6-2, and outputs a resulting signal e6b-3 from a terminal T6b-3 to a terminal T6c-1.

The low-pass filter circuit 6c performs a low-pass filter process on the signal e6b-3, which is fed from the terminal T6b-3 to the terminal T6c-1, and outputs a resulting signal e6c-2 (signal e21) from a terminal T6c-2 to a terminal T21 through a terminal T6-3.

Next, the operation of the transfer-function copying circuit according to Embodiment 2 with the above configuration will be described with reference to FIG. 2

The signal e20 fed to a terminal T6b-2 is given as a quotient signal “en/e2,” which is the signal en divided by a signal e2. Also, the signal e21 at the terminal T6-3 (terminal T21) is given as “e3×en/e2.” Then, a signal e4 is expressed by the following formula.

e₄=e₃·μᵣ(ω)·eₙ (2)

The ratio of the signal e4 to the signal e3 in Mathematical Formula (2) indicates that an equivalent transfer function is equal to the product of the transfer function μr(ω) of a transfer-signal production circuit 7 and the output signal en of the reference-signal output circuit 5c.

Then, by setting the value of the reference signal en to a unit value, for example, the transfer function is copied. Also, the insertion loss by the low-pass filter circuit 6c and the like can be compensated by appropriately setting the reference signal en.

The division circuit 5d in Embodiment 2, which is shown in FIG. 2, can expect such an advantage effect that the dynamic range can be narrowed as compared to the division circuit 6a in Embodiment 1, which is shown in FIG. 1. This is because, the value of one of the signal levels to be divided, or the signal level en, can be set to a constant value, for example.

### Embodiment 3

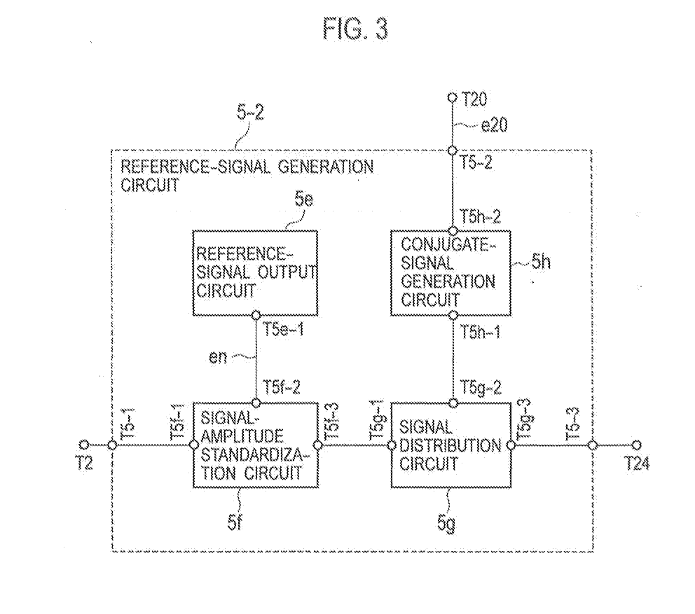

A transfer-function copying circuit 1 in Embodiment 3, which is shown in FIG. 3, is characterized in that it is provided with a reference-signal generation circuit 5-2 instead of the reference-signal generation circuit 5-1 according to Embodiment 2. Specifically, the transfer-function copying circuit 1 in Embodiment 3 is characterized in that it is provided with a conjugate-signal generation circuit 5h instead of the division circuit 5d, thereby improving performance deterioration at high frequencies.

The reference-signal generation circuit 5-2 in Embodiment 3 includes a reference-signal output circuit 5e, a signal-amplitude standardization circuit 5f (also referred to as AGC circuit 5f), a signal distribution circuit 5g, and the conjugate-signal generation circuit 5h.

The reference-signal output circuit 5e generates a signal en and outputs it from a terminal T5e-1 to a terminal T5f-2. The signal-amplitude standardization circuit 5f outputs, as a signal e5f-3, a signal e2 (signal e5f-1) fed from a terminal T5-1 to a terminal T5f-1 and made proportional to the signal en, from a terminal T5f-3 to a terminal T5g-1.

The signal distribution circuit 5g performs a signal distribution process on a signal e5g-1 to distribute and output a signal e5g-2 and a signal e5g-3 (signal e24) from a terminal T5g-2 and a terminal T5g-3 to a terminal T5h-1 and a terminal 124, respectively, the signal e5g-3 (signal e24) being outputted to the terminal T24 through a terminal T5-3.

The conjugate-signal generation circuit 5h performs a process of generating a signal containing, as its mutually orthogonal components, one of two mutually orthogonal components of the signal e5g-2, which is fed from the signal distribution circuit 5g, and a component obtained by inverting the sign of the other component (also referred to as a complex-conjugate-signal generation process), and outputs a resulting signal e5h-2 (signal e20) from a terminal T5h-2 to a terminal T20 through a terminal T5-2.

Meanwhile, a modified circuit of the conjugate-signal generation circuit 5h can be formed. As an example of its configuration, a transfer-function copying circuit 1-1 shown in Embodiment 4 may be such that the terminal T5h-1 of the conjugate-signal generation circuit 5h is a terminal directly coupling a terminal T2 and a terminal T3, and also the terminal T5h-2 of the conjugate-signal generation circuit 5h is a terminal T4 in a circuit configuration without a transfer-signal production circuit 7 and with a terminal T24 and a terminal T25 directly coupled to each other.

The operation of the transfer-function copying circuit according to Embodiment 3 with the above configuration will be described with reference to FIG. 3.

With the phase of its orthogonal component inverted, the signal e20, which is outputted from the conjugate-signal Generation circuit 5h, is the complex conjugate value of en. Thus, a signal e21, which is outputted from a coefficient-signal synthesis circuit 6, is equal to the product of e3 and en. Also, a signal e22 from a transfer-signal relay circuit 8 is equal to the product of a transfer function μr and the signal en. Then, the ratio of a signal e4 to the signal e3 can be expressed by the following formula.

e₄=e₃·μᵣ(ω)·|eₙ|² (3)

The ratio of the signal e4 to the signal e3 in Mathematical Formula (3) indicates that an equivalent transfer function is equal to the product of the transfer function μr(ω) of the transfer-signal production circuit 7 and the square of the absolute value of the signal en. Then, by setting the absolute value of the signal en to a unit value, for example, the transfer function μr(ω) is copied. Meanwhile, an amplification-attenuation circuit may be included such that the value of the signal en can equivalently satisfy the absolute value |en|=1 with the compensation of the insertion loss by a low-pass filter circuit 6f and the like taken into account.

As described above, the reference-signal generation circuit 5-2 in Embodiment 3, which is shown in FIG. 3, can easily handle high frequencies as compared to the reference-signal generation circuit 5-1 in Embodiment 2, which is shown in FIG. 2, by replacing the division circuit 5d with the combination of the conjugate-signal generation circuit 5h and the signal-amplitude standardization circuit 5f.

### Embodiment 4

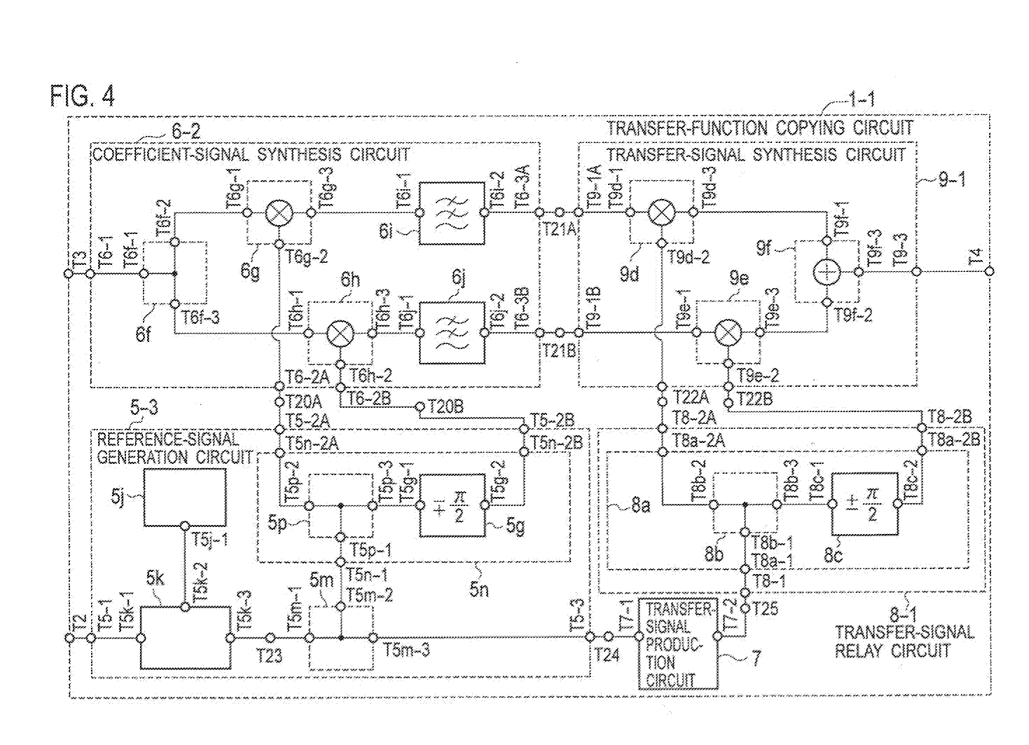

The transfer-function copying circuit 1-1 in Embodiment 4, which is shown in FIG. 4, is characterized in that it performs signal processing by splitting each of signals flowing through relevant current paths that form the transfer-function copying circuit 1 in Embodiment 3, into two mutually orthogonal components of an A component and a B component.

The transfer-function copying circuit 1-1 in Embodiment 4, which is shown in FIG. 4, includes a reference-signal generation circuit 5-3, a coefficient-signal synthesis circuit 6-2, a transfer-signal production circuit 7, a transfer-signal relay circuit 8-1, and a transfer-signal synthesis circuit 9-1.

The reference-signal generation circuit 5-3 includes a reference-signal output circuit a signal-amplitude standardization circuit 5k, a signal distribution circuit 5m, and an orthogonal distribution circuit 5n.

The reference-signal output circuit 5j outputs a signal. en from a terminal T5j-1 to a terminal T5k-2. The signal-amplitude standardization circuit 5k performs a signal amplitude standardization process on a signal e2 fed from a terminal T2 to a terminal T5k-1 through a terminal T5-1, and outputs a signal e5k-3 proportional to the signal en from a terminal T5k-3 to a terminal T5m-1 of the signal distribution circuit 5m.

The signal distribution circuit 5m performs a signal distribution process on the signal e5k-3 to output a signal e5m-2 from a terminal T5m-2 to a terminal T5n-1 and output a signal e5m-3 (signal e24) from a terminal T5m-3 to a terminal T24 through a terminal T5-3.

The orthogonal distribution circuit 5n performs an orthogonal distribution process on the signal e5m-2 to output one of two mutually orthogonal signals e20A and e20B, e.g. the signal e20A from a terminal T5n-2A to a terminal T20A, and output the other signal e20B from a terminal T5n-2B to a terminal T20B.

The orthogonal distribution circuit 5n includes a signal distribution circuit 5p and a phase shift circuit 5g. The signal distribution circuit 5p performs the signal distribution process on a signal e5p-1 fed from the terminal T5n-1 to a terminal T5p-1 to distribute and output a signal e5p-2 (signal e20A) and a signal e5p-3 from a terminal T5p-2 and a terminal T5p-3 to a terminal T5-2A and a terminal T5g-1, respectively, the signal e5p-2 (signal e20A) being outputted to the terminal T5-2A through a terminal T5n-2A.

The phase shift circuit 5g shifts the phase of the signal e5p-3 by “−90,” for example, and outputs a resulting signal e5q-2 (signal e20B) from a terminal T5g-2 to a terminal T5-2B through the terminal T5n-2B. The signal e20A and the signal e20B are signals orthogonal to each other.

The coefficient-signal synthesis circuit 6-2 includes a signal distribution circuit 6f, a multiplication circuit 6g, a multiplication circuit 6h, a low-pass filter circuit 6i, and a low-pass filter circuit 6j.

The signal distribution circuit 6f performs a signal distribution process on a signal e3 fed from a terminal T3 to a terminal T6f-1 through a terminal T6-1, to output a signal e6f-2 from a terminal T6f-2 to a terminal T6g-1 and output a signal e6f-3 from a terminal T6f-3 to a terminal T6h-1.

The multiplication circuit 6g performs a multiplication process on the signal e6f-2 and a signal e6-2A (signal e20A) and outputs a resulting signal e6g-3 from a terminal T6g-3 to a terminal T6i-1. The multiplication circuit 6h performs a multiplication process on the signal e6f-3 and a signal e6-2B (signal e20B) and outputs a resulting signal e6h-3 from a terminal T6h-3 to a terminal T6j-1.

The low-pass filter circuit 6i performs a low-pass filter process on the signal e6g-3 and outputs a resulting signal e6i-2 from a terminal T6i-2 to a terminal T21A through a terminal T6-3A. The low-pass filter circuit 6j performs a low-pass filter process on the signal e6h-3 and outputs a resulting signal e6j-2 from a terminal T6j-2 to a terminal T21B through a terminal T6-3B.

The functions of the lowpass filter circuit 6i and the low-pass filter circuit 6j are essential. However, there cases where the effect of response lag between the inputs and outputs of transistors, for example, which form the multiplication circuit 6g and the multiplication circuit 6h can be utilized as those functions. In such cases, the two low-pass filter circuits 6i and 6j are not necessary.

The transfer-signal relay circuit 8-1 includes an orthogonal distribution circuit 8a. The orthogonal distribution circuit 8a performs an orthogonal distribution process on a signal e8-1 fed from a terminal T25 to a terminal T8a-1 through a terminal T8-1, to output one of two mutually orthogonal signals e22A and e22B, e.g. a signal e8-2A (signal e22A) from a terminal T8a-2A to a terminal T22A through a terminal T8-2A and output the other signal e8-2B (signal e22B) from a terminal T8a-2B to a terminal T22B through a terminal T8-2B.

The orthogonal distribution circuit 8a includes a signal distribution circuit 8b and a phase shift circuit 8c. The signal distribution circuit 8b performs a signal distribution process on the signal e8-1 fed from the terminal T8a-1 to a terminal T8b-1, to output a signal e8b-2 (signal e22A) from a terminal T8b-2 to the terminal T8a-2A through the terminal T8a-2A and output a signal e8b-3 from a terminal T8b-3 to a terminal T8c-1.

The phase shift circuit 8c shifts the phase of the signal e8b-3 by “+90,” for example, and outputs a resulting signal e8c-2 (signal e22B) from a terminal T8c-2 to the terminal T8-2B through the terminal T8a-2B,

The transfer-signal synthesis circuit 9-1 includes a multiplication circuit 9d, a multiplication circuit 9e, and a signal addition-subtraction circuit 9f. The multiplication circuit 9d performs a multiplication process on a signal e21A (signal e9d-1) and the signal e22A (signal e9d-2) and outputs a resulting signal e9d-3 from a terminal T9d-3 to a terminal T9f-1. The multiplication circuit 9e performs multiplication process on a signal e21B (signal e9e-1) and the signal e22B (signal e9e-2) and outputs a resulting signal e9e-3 from a terminal T9e-3 to a terminal T9f-2.

The signal addition-subtraction circuit 9f performs either an addition process or a subtraction process on the signal e9d-3 and the signal e9e-3 and outputs a resulting signal e9f-3 (signal e4) from a terminal T9f-3 to a terminal T4 through a terminal T9-3.

The addition process or the subtraction process may be selected by checking the signs of the amounts of phase shift “−90” and “+90” selected and set for the phase shift circuit 5g and the phase shift circuit 8c, and also by checking whether or not a phase inversion amplification circuit or the like is provided on the relevant current paths.

Meanwhile, though not shown, an amplification-attenuation circuit 9g may be disposed between the terminal T9f-3 and the terminal T4, for example, if necessary. The purpose is to perform a process of setting a constant of 0.5 necessary for the addition-subtraction process by the signal addition-subtraction circuit 9f, and to perform a process of adjusting the output amplitude en of the reference-signal output circuit 5j (a unit amplitude as a reference).

For these two processes, there is synergistic processing of a plurality of amplification-attenuation processes. Thus, appropriate values can be set by the operation of the amplification-attenuation circuit 9g. Also, the function of the amplification-attenuation circuit 9g can be incorporated as a constant form in the transfer process by the transfer-signal production circuit 7 or the like, in which case the amplification-attenuation circuit 9g can be omitted.

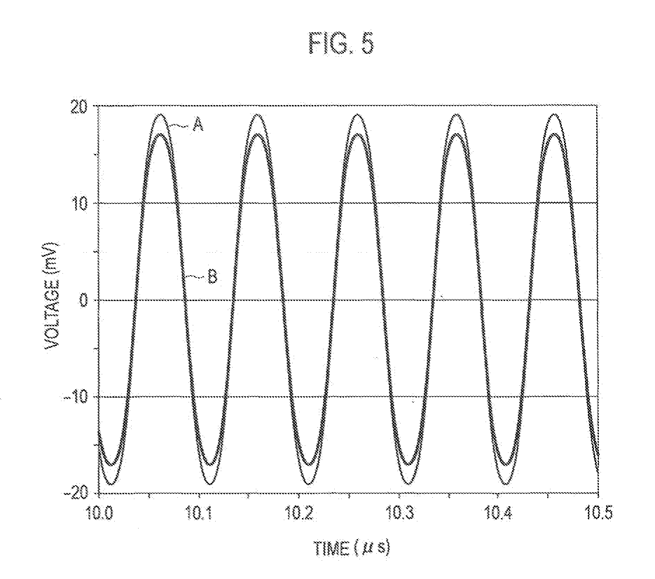

Next, using FIG. 5, description will be given of the results of time-domain numerical simulations in a steady state at a frequency of 10 MHz. The transfer-signal production circuit (conversion target circuit) 7 forms a series resonant circuit including a coil (10 μH), a capacitor (25.330296 pF), and a resistor (1Ω). Its resonant frequency is 10 MHz. The horizontal axis shown in FIG. 5 is time, and its range is from 10 μS to 10.5 μS. The vertical axis is the instantaneous value of voltage, and a narrow line A represents the voltage at the second input terminal T3 and a bold line B represents the voltage at the output terminal T4.

Also, as an external circuit E2 as an optional circuit that feeds the second input terminal T3 with the signal e3, which contains the same frequency components as the signal e2 inputted to the first input terminal T2, a low-pass filter formed of a 10-μH coil and a 1-nF capacitor is connected under a terminal condition where the input and output impedances are 1 kΩ. An external circuit E1 is a direct coupled circuit.

The results of the following two simulations show that the transfer function μr(ω) of the transfer-signal production circuit 7 (conversion target circuit) is copied.

As shown in FIG. 5, as for the transfer ratio of the signal at the output terminal T4 to a sine-wave signal at a frequency of 10 MHz fed to the second input terminal T3, a sine-wave signal proportional to the input-output signal ratio μr(ω) of the transfer-signal production circuit 7 is produced in an in-phase state.

Meanwhile, though not shown, in cases where the frequency fed to the first input terminal T2 and the second input terminal T3 is varied to 9900 kHz, 10000 kHz, and 10100 kHz, the phase of the signal at the output terminal T4 shows phase characteristics of phase lead, in-phase, and phase lag, respectively in the phase lead state and the phase lag state, the amplitude at the output terminal T4 is attenuated as compared to that in the in-phase state.

Also, in a case where the optional connected circuit is other than the low-pass filter mentioned above, an output signal proportional to the input-output signal ratio μr(ω) of the transfer-signal production circuit 7 is obtained as well, indicating that an aimed transfer-function copying process is realized.

### Embodiment 5

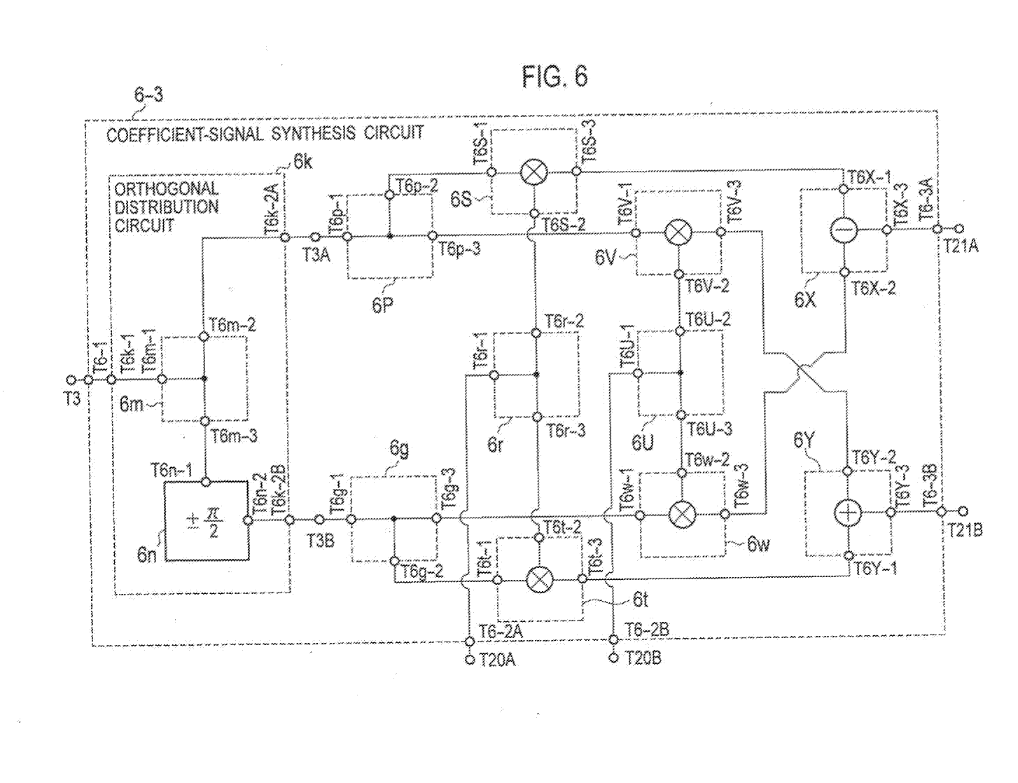

Embodiment 5 is characterized in that a coefficient-signal synthesis circuit 6-3, shown in FIG. 6, does not use the two low-pass filter circuits 6i and 6j, shown in Embodiment 4, to thereby reduce external components for LSI and also improve performance deterioration in rise characteristic.

In a transfer-function copying circuit 1 shown in Embodiment 5, only the configuration of the coefficient-signal synthesis circuit 6-3 is modified from Embodiment 4, which is shown in FIG. 4. For this reason, the following will describe only the coefficient-signal synthesis circuit 6-3.

The coefficient-signal synthesis circuit 6-3 includes an orthogonal distribution circuit 6k, a signal distribution circuit 6p, a signal distribution circuit 6g, a signal distribution circuit 6r, a multiplication circuit 6s, a multiplication circuit 6t, a signal distribution circuit 6u, a multiplication circuit 6v, a multiplication circuit 6w, a signal addition-subtraction circuit 6x, and a signal addition-subtraction circuit 6y.

The orthogonal distribution circuit 6k performs an orthogonal distribution process on a signal e6k-1 (signal e3) fed from a terminal T6-1 to a terminal T6k-1, to output one of two mutually orthogonal signals e3A and e3B, e.g. the signal e3A (signal e6k-2A) from a terminal T6k-2A to a terminal T6p-1 through a terminal T3A and output the other signal e3B (signal e6k-2B) from a terminal T6k-2B to a terminal T6g-1 through a terminal T3B.

The signal distribution circuit 6p performs a signal distribution process on the signal e6k-2A to output a signal e6p-2 from a terminal T6p-2 to a terminal T6s-1 and output a signal e6p-3 from a terminal T6p-3 to a terminal T6v-1. The signal distribution circuit 6g performs a signal distribution process on the signal e6k-2B to output a signal e6g-2 from a terminal T6g-2 to a terminal T6t-1 and output a signal e6g-3 from a terminal T6g-3 to a terminal T6w-1.

The signal distribution circuit 6r performs a signal distribution process on a signal e20A fed from a terminal T20A to a terminal T6r-1 through a terminal T6-2A, to output a signal e6r-2 from a terminal T6r-2 to a terminal T6s-2 and output a signal e6r-3 from a terminal T6r-3 to a terminal T6t-2.

The multiplication circuit 6s performs a multiplication process on the signal e6p-2 and the signal e6r-2 and outputs a resulting signal e6s-3 from a terminal T6s-3 to a terminal T6x-1. The multiplication circuit 6t performs a multiplication process on the signal e6g-2 and the signal e6r-3 and outputs a resulting signal e6t-3 from a terminal T6t-3 to a terminal T6y-1.

The signal distribution circuit 6u performs a signal distribution process on a signal e20B fed from a terminal T20B to a terminal T6u-1 through a terminal T6-2B, to output a signal e6u-2 from a terminal T6u-2 to a terminal T6v-2 and output a signal e6u-3 from a terminal T6u-3 to a terminal T6w-2.

The multiplication circuit 6v performs a multiplication process on the signal e6p-3 and the signal e6u-2 and outputs a resulting signal e6v-3 from a terminal T6v-3 to a terminal T6y-2. The multiplication circuit 6w performs a multiplication process on the signal e6q-3 and the signal e6u-3 and outputs a resulting signal e6w-3 from a terminal T6w-3 to a terminal T6x-2.

The signal addition-subtraction circuit 6x performs an addition-subtraction process on the signal e6s-3 and the signal e6w-3 and outputs a resulting signal e6x-3 from a terminal T6x-3 to a terminal T21A through a terminal T6-3A. The signal addition-subtraction circuit 6y performs an addition-subtraction process on the signal e6t-3 and the signal e6v-3 and outputs a resulting signal e6y-3 from a terminal T6y-3 to a terminal T21B through a terminal T6-3B.

The orthogonal distribution circuit 6k includes a signal distribution circuit 6m and a phase shift circuit 6n. The signal distribution circuit 6m performs a signal distribution process on the signal e6k-1 fed from the terminal T6k-1 to a terminal T6m-1, to output a signal e6m-2 from a terminal T6m-2 to the terminal T3A through the terminal T6k-2A and output a signal e6m-3 from a terminal T6m-3 to a terminal T6n-1. The phase shift circuit 6n shifts the phase of the signal e6m-3 by for example, and outputs a resulting signal e6n-2 from a terminal T6n-2 to the terminal T3B through the terminal T6k-2B.

Next, the operation of the coefficient-signal synthesis circuit 6-3 in Embodiment 5 with the above configuration will be described with reference to FIG. 6.

From FIG. 6, the signal e3A at the terminal T3A is in phase with the signal e3, and the signal e3B at the terminal T3B is orthogonal to the signal e3 at a terminal T3. Also, from FIG. 4, the signal e20A at the terminal T20A is in phase with a signal e2 at a terminal T2, and the signal e20B at the terminal T20B is orthogonal to the signal e2 at the terminal T2.

A product signal obtained by performing a multiplication operation on one of an A signal and a B signal being mutually orthogonal signals in the signal e2 and one of an A signal and a B signal being mutually orthogonal signals in the signal e3, e.g., a product signal obtained by performing multiplication operation on the A signal in the signal e2 and the B signal in the signal e3 (AB product signal), contains a two-times higher frequency component and a zero-frequency component (phase components).

In the signal addition-subtraction circuit 6x, which is shown in FIG. 6, as a signal e6x-1 fed to the terminal T6x-1, a signal obtained by inverting the sign of a signal containing a component being the sum of the total component of the frequency component and the phase component of the signal e2 and the total component of the frequency component and the phase component of the signal e3, and a signal containing a component being the difference between the total component of the frequency component and the phase component of the signal e2 and the total component of the frequency component and the phase component of the signal e3, are inputted.

Also, as a signal e6x-2 fed to the terminal T6x-2, a signal containing a component being the sum of the total component of the frequency component and the phase component of the signal e2 and the total component of the frequency component and the phase component of the signal e3, and a signal containing a component being the difference between the total component of the frequency component and the phase component of the signal e2 and the total component of the frequency component and the phase component of the signal e3, are inputted.

Here, in a case where the subtraction is employed between the addition and the subtraction in the addition-subtraction process by the signal addition-subtraction circuit 6x, the signal e6x-3, which is outputted from the terminal T6x-3, is such that the sum frequency signal components are cancelled out, and a signal with an amplitude twice higher than the difference signal components (difference frequency signal components) is outputted. As a result, a coefficient signal e21A related to one of the in-phase and orthogonal components is generated.

This operation works as long as a subtraction process is performed on two signals with an equal amplitude, and the phase difference between the in-phase and orthogonal components is “+90.”

Each sum component mentioned above contains a frequency component that is two times higher than the frequency inputted into the terminal T2, whereas each difference component does not contain the two-times higher frequency component. For this reason, in Embodiment 5, the low-pass filter circuit 6i and the like shown in Embodiment 4 are not necessary. This difference component has such frequency dependence that it is dependent on the circuit E1 and the circuit E2, which are optional circuits shown in FIG. 1.

Likewise, the signal addition-subtraction circuit 6y generates a coefficient signal e21B related to the other of the in-phase and orthogonal components, though description thereof will be omitted.

The addition or the subtraction in the addition-subtraction process by each of the signal addition-subtraction circuit 6x and the signal addition-subtraction circuit 6y may be selected by checking the relation between the signal e20A and the signal e20B and between a signal e22A and a signal e22B in terms of the signs of their phases, and also by checking whether or not a phase inversion amplification circuit or the like is provided on the relevant current paths.

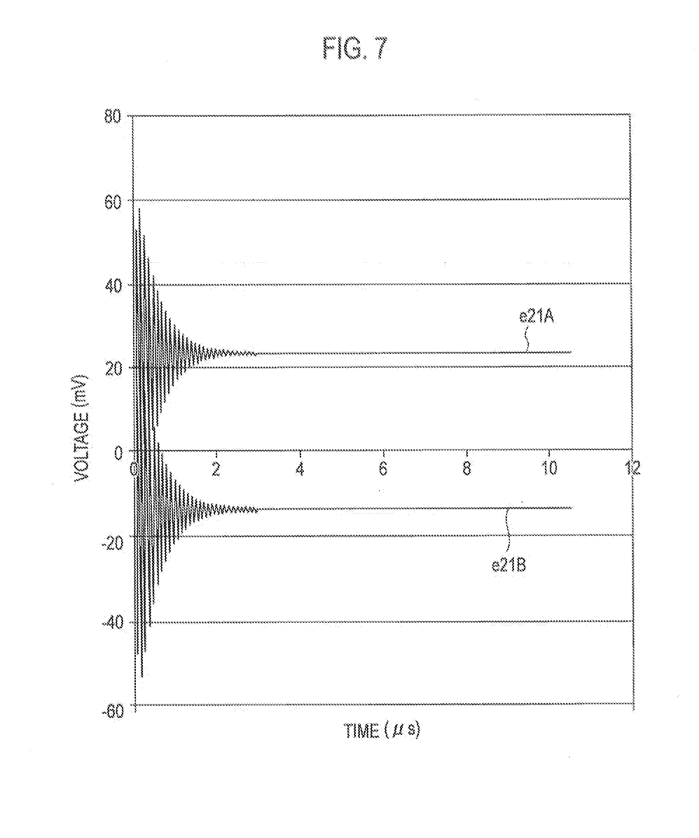

Using FIG. 7, description will be given of the results of time-domain numerical simulations on the two coefficient signals e21A and e21B at the terminals T21A and T21B in the coefficient-signal synthesis circuit 6-3. In the simulations, the circuit constants of the transfer-signal production circuit 7 and the external circuits E1 and E2 are the same as those in Embodiment 4.

The horizontal axis is time, and its range is from 0 μS to 10.5 μS. The vertical axis is the voltage V of the signal e21A at the coefficient-A-signal terminal T21A and of the signal e223 at the coefficient-B-signal terminal T21B in a state where an output signal en from a reference-signal output circuit 5r (not shown) is 1.4142 V (peak value). These two coefficient signals have frequency characteristics.

In the results of the simulations, no ripple of a frequency component twice higher than 10 MHz is observed. The marked transient phenomenon up to about 3 μS is a phenomenon mainly attributable to the external circuits E1 and E2. On the other hand, though not shown, in Embodiment4, residual ripples are observed that are attributable to the fact that the cut-off characteristics of the low-pass filter circuit 6h and the low-pass filter circuit 6j are insufficient. In contrast, in Embodiment 5, no residual ripple is observed, which clearly indicates an effect. Moreover, the rise characteristic is improved.

The coefficient-signal synthesis circuit 6-3 in Embodiment 5 does not use the two low-pass filter circuits 6i and 6j, which are shown in Embodiment 4, and brings about such an advantage effect that only a DC component without a frequency twice higher than the frequency inputted into the terminal T2 and the terminal T3 appears on the two mutually orthogonal coefficient A signal e21A and coefficient B signal e21B.

Thus, in a case for example where the orthogonal distribution circuit is formed using analog components instead of a digital circuit, intended reactance elements other than the reactance element that forms the phase shift circuit are not necessary. In this way, external components for LSI can be reduced.

### Embodiment 6

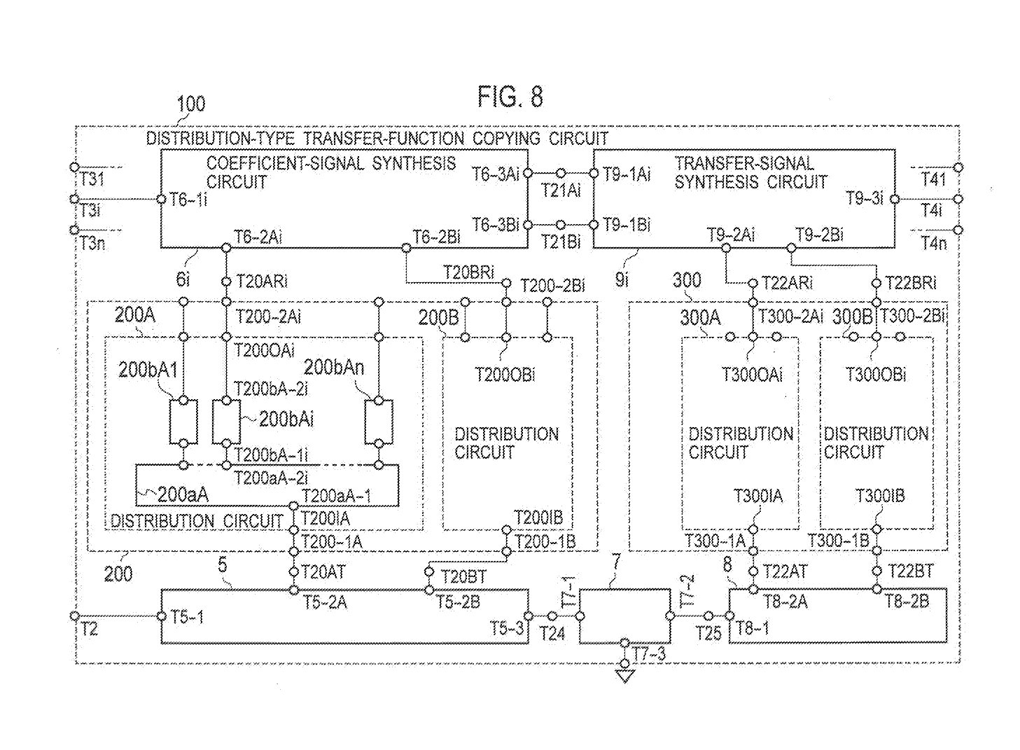

FIG. 8 is a diagram showing the configuration of a distribution-type transfer-function copying circuit in Embodiment 6. A distribution-type transfer-function copying circuit 100, which is shown in FIG. 8, includes a reference-signal distribution circuit 200 and a relayed-signal distribution circuit 300 in the configuration of a transfer-function copying circuit 1. This allows a function to copy similar copied signals at a plurality of pairs of coefficient-signal synthesis circuits 6i and transfer-signal synthesis circuits 9i, which are copy destinations.

The following will omit description of the configuration of the transfer-function copying circuit 1. Only the reference-signal distribution circuit 200 and the relayed-signal distribution circuit 300 will be described using FIG. 8.

In the example shown, a transfer-signal production circuit forming the distribution-type transfer-function copying circuit 100, which is shown in FIG. 8, is provided with a terminal T7-3, and this terminal T7-3 is connected to a reference terminal. However, the terminal T7-3 is riot necessarily required.

To further include the reference-signal distribution circuit 00 and the relayed-signal distribution circuit 300, first-reference-signal terminals 120A and 120B and relayed signal terminals 122A and 122B of the transfer-function copying circuit 1 are each divided into a plurality of terminals on a transmission side and a reception side in distribution, as described below.

For simplicity, the description will be given such that each reference-A-signal reception terminal T20ARi (i=1, n) for example, will be expressed as “reference-A-signal reception terminal T20ARi” without (i=1, n). That is, each time the small letter “i” appears, it means (i=1, n) is mentioned.

In the distribution-type transfer-function copying circuit 100, which is shown in Embodiment 6, the reference-A-signal terminal T20A is divided into a reference-A-signal transmission terminal T20A1 and reference-A-signal reception terminals T20ARi. The reference-B-signal terminal T20B is divided into a reference-B-signal transmission terminal T20BT and reference-B-signal reception terminals T20BRi, The relayed-A-signal terminal T22A is divided into a relayed-A-signal transmission terminal T22AT and relayed-A-signal reception terminals T22ARi. The relayed-B-signal terminal T22B as divided into a relayed-B-signal transmission terminal T22BT and relayed-B-signal reption terminals T22BRi. Thus, the signal at each terminal is defined distinctively from the other(s).

The embodiment will be described in detail below.

The distribution-type transfer-function copying circuit 100 includes a first input terminal T2, input terminals T3i for the coefficient-signal synthesis circuits 6i, output terminals T4i for the transfer-signal synthesis circuits 9i, the reference-signal distribution circuit 200, the coefficient-signal synthesis circuits 6i, the relayed-signal distribution circuit 300, and the transfer-signal synthesis circuits 9i.

The reference-signal distribution circuit 200 includes a distribution circuit 200A and a distribution circuit 200B. The relayed-signal distribution circuit 300 includes a distribution circuit 300A and a distribution circuit 300B.

The distribution circuit 200A performs a distribution process on a coefficient A signal e20AT fed from the terminal T20AT to a terminal T200IA through a terminal T200-1A, outputs resulting signals e200OAi from terminals T200OAi to terminals T200-2Ai, and distributes and feeds them to terminals T6-2Ai of the i-th coefficient-signal synthesis circuits 6i through the terminals T20ARi, respectively.

The distribution circuit 200B performs a distribution process on a coefficient B signal e20BT fed from the terminal T20BT to a terminal T200IB through a terminal T200-1B, outputs resulting signals e200OBi from terminals T200OBi to terminals T200-2Bi, and distributes and feeds them to terminals T6-2Bi of the coefficient-signal synthesis circuits 6i through the terminals T20BRi, respectively.

Each coefficient-signal synthesis circuit 6i performs a coefficient-signal synthesis process on a signal e3i fed to the terminal T3i and the signal e200OAi and the signal e2000Bi fed respectively to the terminal T6-2Ai and the terminal T6-2Bi, outputs a resulting signal e21Ai from a terminal T6-3Ai to a terminal T21Ai, and outputs a resulting signal e21Bi from a terminal T6-3Bi to a terminal T21Bi.

The distribution circuit 300A performs a distribution process on a coefficient A signal e22AT fed from the terminal T22AT to a terminal T300IA through a terminal T300-1A, outputs resulting signals e300OAi from terminals T300OAi to terminals T300-2A1, and distributes and feeds them to terminals T9-2Ad of the i-th coefficient-signal synthesis circuits 9i through the terminals T22ARi.

The distribution circuit 300B performs a distribution process on a coefficient B signal e22BT fed from the terminal T223T to a terminal T300IB through a terminal T300-1B, outputs resulting signals e3000Bi from terminals T3000Bi to terminals T300-2Bi, and distributes and feeds them to terminals T9-2Bi of the i-th transfer-signal synthesis circuits 9i through the terminals T22BRi.

Each transfer-signal synthesis circuit 9i performs a coefficient-signal synthesis process on the signal e21Ai fed to a terminal T9-1Ai, the signal e21Bi fed to a terminal T9-1Bi, a signal e22ARi fed to the terminal T9-2Ai, and a signal e22BRi fed to the terminal T9-2Bi, and outputs a resulting signal e4i from a terminal T9-3i to the terminal T4i.

The distribution circuit 200A and the distribution circuit 200B form the reference-signal (distribution circuit 200. The distribution circuit 300A and the distribution circuit 300B form the relayed-signal distribution circuit 300.

The distribution circuit 200A, the distribution circuit 200B, the distribution circuit 300A, and the distribution circuit 300B have the same configuration. Thus, the configuration of only the distribution circuit 200A will be described, and description of the other distribution circuits will be omitted.

The distribution circuit 200aA includes a signal distribution circuit 200aA and buffer circuits 200bAd.

The signal distribution circuit 200aA performs a 1:n signal distribution process on the signal e20AT inputted from the terminal T200IA to a terminal T200aA-1, to output each resulting signal e200aA-2i from a terminal T200aA-2i to a terminal T200bA-1i.

Each buffer circuit 200bAi performs a reverse attenuation process on the signal e200aA-2i, which is inputted from the terminal T200aA-2i to the terminal T200bA-1i, and outputs a resulting signal e200bA-2i from a terminal T200bA-2i to the terminal T200OAi.

The buffer circuit 200bAi prevents abnormal oscillation by performing an attenuation process on unintended closed loop gain. Thus, at least a signal flowing backward against the direction of flow of the intended signal is attenuated. The buffer circuit 200bAi may be a general buffer amplification circuit, an isolator or circulator, or an attenuation circuit that applies bidirectional attenuation.

Meanwhile, one practical design choice for the distribution circuit 200aAi and the distribution circuit 200aBi and for and the distribution circuit 300aAi and the distribution circuit 300aBi may be such that each of them includes an oscillation compensation circuit and a phase compensation circuit since each pair are components with an equal amplitude and orthogonal phases. Also, they may each include a lag compensation circuit if it is necessary to compensate a lag resulting from the difference in wiring length between distribution wirings.

The signal wirings forming each pair may be a single-ended drive formed of two signal wirings or a differential drive formed of four signal wirings. Alternatively, twisted pair wirings with a three-dimensional structure may be employed.

As described above, in the distribution-type transfer-function copying circuit 100 according to Embodiment 6, a transfer function produced by a single transfer-signal production circuit 7 is distributed and fed to a plurality (n) of pairs of coefficient-signal synthesis circuits 6i and transfer-signal synthesis circuits 91. As a result, the transfer function signal produced by the single transfer-signal production circuit 7 is distributed and outputted between the plurality (n) of pairs of i-th second input terminals T3i and i-th output terminals T4i (copy destinations). In other words, the transfer function signal is copied.

Next, description will be given of modifications of the transfer-function copying circuits 1 in Embodiment 1 to Embodiment 5 and the distribution-type transfer-function copying circuit 100 in Embodiment 6.

Embodiment 1 to Embodiment 6 have been described on the assumption of analog processing. However, the technique disclosed by the present invention is not limited only to analog processing and may be digital processing.

The embodiments will be described further in detail. In the transfer-function copying circuits 1 in Embodiment 1 to Embodiment 5 and the distribution-type transfer-function copying circuit 100 in Embodiment 6, a signal fed to at least one input terminal and a signal outputted from at least one output terminal are both analog signals.

Further, the description has been given using the embodiments assuming that the circuits that process those signals are analog circuits or combinations of analog elements. However, these analog circuits or combinations of analog elements may be digital processing. In that case, for example, an analog signal fed to at least one input terminal is converted into a digital signal by an AD converter connected to the terminal. The at least one digital signal after the digital processing is outputted as an analog signal from an output terminal by a DA converter connected to at least one terminal. The digital processing suffices to be digital processing equivalent to the processing in the transfer-function copying circuits in Embodiment 1 to Embodiment 5 and the distribution-type transfer-function copying circuit in Embodiment 6.

The embodiments will be described further in detail below.

For Embodiment 1 to Embodiment 5, the transfer-function copying circuits 1 suffice to include a first analog-digital conversion circuit, a second analog-digital conversion circuit, and a first digital-analog conversion circuit. The first analog-digital conversion circuit performs analog-digital conversion on the analog signal fed to the first input terminal T2. The second analog-digital conversion circuit performs analog-digital conversion on the analog signal fed to the second input terminal T3. The first digital-analog conversion circuit performs digital-analog conversion on the digital signals subjected to the transfer-signal synthesis process and outputs the resulting signal to the (first) output terminal T4.

For Embodiment 6, the distribution-type transfer-function copying circuit 100 suffices to include a first analog-digital conversion circuit, a plurality of i-th second analog-digital conversion circuits, and a plurality of i-th first digital-analog conversion circuits.

The first analog-digital conversion circuit performs analog-digital conversion on the analog signal fed to the first input terminal T2. The plurality of i-th second analog-digital conversion circuits perform analog-digital conversion on the analog signals fed to the plurality of i-th second input terminals 131. The plurality of i-th first digital-analog conversion circuits perform digital-analog conversion on the digital signals subjected to the transfer-signal synthesis process by the plurality of transfer-signal synthesis circuits 9i, and output the resulting analog signals to the (i-th first) output terminals T4i, respectively.

Now, if the process by the transfer-signal production circuit 7 is to be performed by means of analog processing, the transfer-function copying circuits 1 in Embodiment 1 to Embodiment 5 and the distribution-type transfer-function copying circuit 100 in Embodiment 6 suffice to include a second digital-analog conversion circuit and a third analog-digital conversion circuit, for example.

The second digital-analog conversion circuit converts the digital signal fed to the terminal T7-1 into an analog signal. The third analog-digital conversion circuit converts the analog signal subjected to the transfer-function production process by the transfer-signal production circuit 7, into a digital signal.

Alternatively, the transfer-function copying circuits 1 in Embodiment 1 to Embodiment 5 and the distribution-type transfer-function copying circuit 100 in Embodiment 6 may include a third analog-digital conversion circuit. The third analog-digital conversion circuit converts an analog signal into a digital signal, the analog signal being the analog signal fed to the first input terminal T2, distributed in an analog manner, and subjected to the transfer-function production process by the transfer-signal production circuit 7.

### Embodiment 7

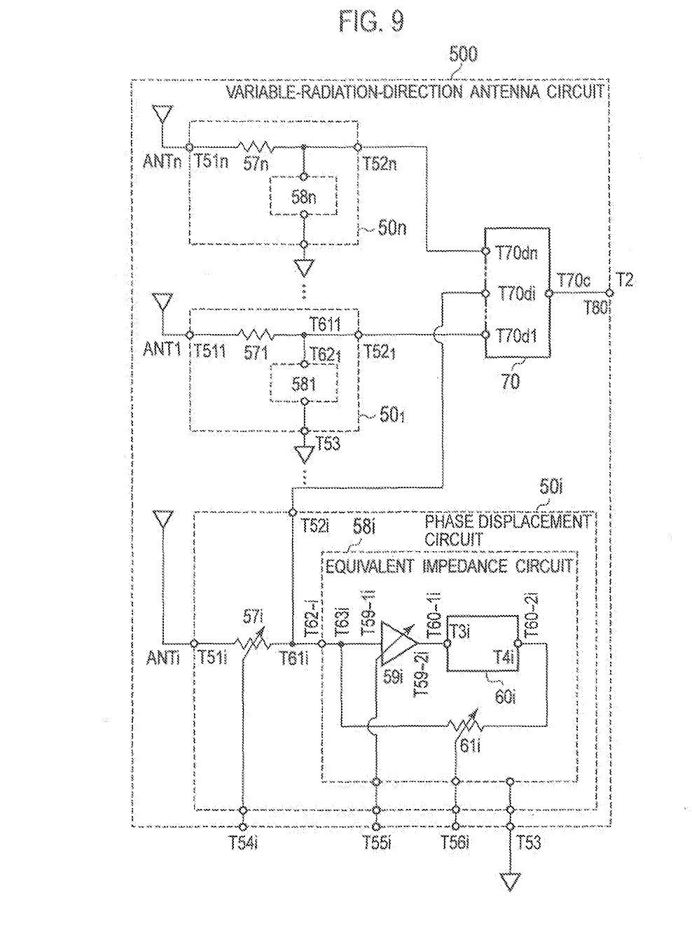

FIG. 9 is a diagram showing the configuration of a gang-controlled phase displacement circuit in Embodiment 7. The gang-controlled phase displacement circuit in Embodiment 7 utilizes the distribution-type transfer-function copying circuit 100, which is shown in Embodiment 6, and is formed by a variable-radiation-direction antenna circuit 500, which is utilized as a circuit that makes the radiation directions of antennas variable, for example.

The variable-radiation-direction antenna circuit 500 will be described using FIG. 9. The variable-radiation-direction antenna circuit 500 includes phase displacement circuits 50i. In each phase displacement circuit 50i, a single resistive element P57i connected in series to an antenna ANTi, and a single inductive element 58i equivalent to a shunt branch are disposed.

For simple description, each antenna ANTi (i=1, n.), for example, will be expressed as “antenna ANTi” without (i=1, n)

The variable-radiation-direction antenna circuit 500 includes: n antennas ANTi; n phase displacement circuits 50i that control individual amounts of phase displacement in association with each other; a coupling circuit 70 that performs a distribution coupling process on the n phase displacement circuits 50i and a single transmission-reception device (n. vs 1); and an input-output terminal T80 to which a transmitter, receiver, or a transmitter-receiver is connected.

Each phase displacement circuit 50i includes a terminal T51i, a terminal T52i, a reference terminal T53, an impedance-element-value control terminal T54i, a gain control terminal T55i, and a feedback-impedance-element-value control terminal T56i.

The phase displacement circuit 50i further includes the impedance element 57i and the equivalent impedance circuit 58i. The impedance element 57i has one terminal connected to the terminal T51i and has the other terminal connected to the terminal T52i and a terminal T62i through a node T61i, and makes an impedance value Rsi variable in accordance with a signal fed from the terminal T54i. The equivalent impedance circuit 58i performs an equivalent impedance element process on a signal e62i fed to the terminal T62i.

The equivalent impedance circuit 58i includes the distribution-type transfer-function copying circuit 100 in Embodiment 6 as its circuit 60i. The equivalent impedance circuit 58i has a reference terminal connected to the reference terminal T53.

The equivalent impedance circuit 58i includes a variable amplification-attenuation circuit 59i, the circuit 60i (distribution-type transfer-function copying circuit 100), a variable amplification-attenuation circuit 59i, and a feedback impedance circuit 61i.

The variable amplification-attenuation circuit 59i performs an amplification-attenuation process on a signal fed from the terminal T62i to a terminal T59-1i through a node T63i with an amplification-attenuation rate A0 in accordance with a signal fed to the terminal T55i, and outputs a resulting signal. e59-2i from a terminal T59-2i to a terminal 60-1i (terminal T3i).

The circuit 60i performs an equivalent transfer function process with an equivalent transfer function μr(ω) on the signal e59-2i, which is fed to the terminal 60-1i (second input terminal T3i), and outputs a resulting signal e4i from a terminal 60-2i (terminal T4i) to one of the terminals of the feedback impedance element 61i.

The feedback impedance circuit 61i performs a feedback impedance process with zfi on the signal e4i in accordance with a signal fed to the terminal T56i, and outputs the resulting signal from the other terminal to the node T63i. The first input terminal T2 of the distribution-type transfer-function copying circuit 100 may be connected to the terminal T80, for example.

Note that, as the variable amplification-attenuation circuit 59i, a variable amplification-attenuation circuit including an input terminal and an output terminal inverted in phase may be used. This variable amplification-attenuation circuit forms two inverse-connection feedback loops inverted relative to each other in phase. The transfer-signal production circuit 60i and the feedback impedance circuit 61i are disposed at one of the inverse-connection feedback loops, and the circuit constant value of a second feedback circuit 64i (not shown) including an external adjustment terminal provided at the other inverse-connection feedback loop is disposed. In this way, “1” of the dominator of the transfer function of the whole feedback circuit can be reduced.

The coupling circuit 70 includes a plurality of impedance elements connecting between all distribution terminals T70di and a common terminal T70c in a star pattern. Meanwhile, this coupling circuit 70 may be a demultiplexing circuit or a multiplexing circuit.

The terminal T70c may be divided into two terminals and connected to a transmitter and a receiver or a transmitter-receiver through an input terminal 80I and an output terminal 80O.

Also, in an example of the configuration of a transfer-signal production circuit 7 that forms the distribution-type transfer-function copying circuit 100, a resistive element value R is connected between a terminal T7-1 and a terminal T7-2, and a capacitive element value is connected between the terminal T7-2 and a reference terminal T7-3 (not shown). In this way, a transfer function being the reciprocal of 1+(ωτ)×(ωτ) is obtained, where τ is given as the product of the resistive element value and the capacitive element value.

Alternatively, both or one of the capacitance value and the resistance value, e.g., the element value of the capacitive element, may be externally controlled in accordance with a signal fed to a control terminal T7-4 (not shown), to thereby make the time constant τ externally variable.

Next, the results of simulations in Embodiment 7 will be described. The circuit design and circuit constants of the transfer-signal production circuit 7 are set as follows. A 10-Ω resistor is connected between the terminal T7-1 and the terminal T7-2 of the transfer-signal production circuit 7, and a capacitor with variable capacitance values is connected between the terminal T7-2 and the terminal T7-3 which is connected to the reference terminal, and the value of the capacitor is varied from 53 pF to 50 pF. The resistance value of the resistive element 57i is 10 Ω. The attenuation-amplification rate A0 of the variable attenuation-amplification circuit 59i as a parameter is set to −2, −1.3333, −1.1428, and −1.0667.

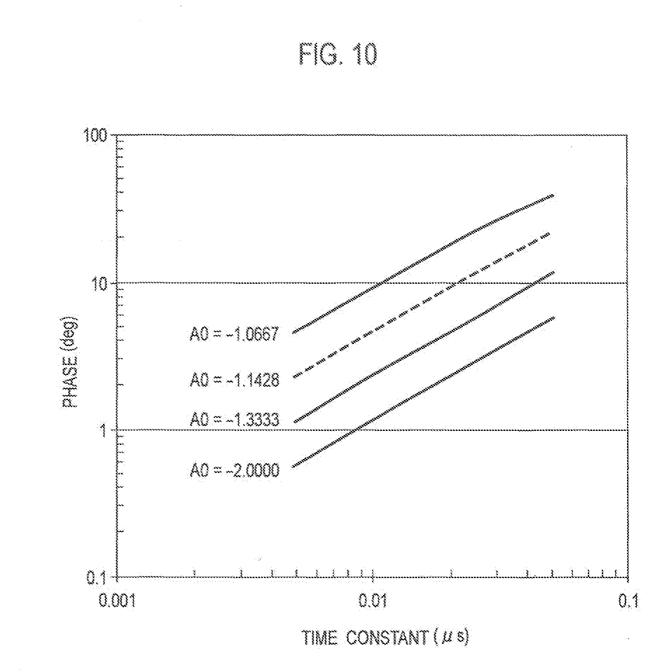

FIG. 10 shows the results of the simulations. The horizontal axis of FIG. 10 represents the time constant in “μs.” The vertical axis represents the amount of phase displacement in degree. The operation frequency is 1 GHz. The slight saturation phenomenon observed at large values on the vertical axis can be corrected by controlling the resistance value of the resistive element 57i, for example.

As for the positive and negative signs on the vertical axis of FIG. 10, the direction in which the phase displacement can be varied can be inverted by inserting a phase inversion circuit in the transfer-signal production circuit 7, for example. This is because the value of the equivalent impedance produced between the terminal T3i and the terminal T4i can be set to any one of a negative value and a positive value.

Also, the phase displacement circuit 50i may be a circuit obtained by replacing the element values of some circuit elements in an all-pass filter circuit i with a 3i terminal and a 4i terminal.

It is also possible to employ a circuit including a plurality of antennas, a plurality of phase shift circuits, and a coupling circuit that couples at least one transmission or reception circuit or transmission-reception circuit thereto.

Also, the phase displacement circuit may be a phased array circuit characterized by including the second input terminal T3i (i=1, n) and the output terminal T4i (i=1, n) of the transfer-function copying circuit and a variable amplification-attenuation circuit including an amplification-attenuation-gain control terminal, on current paths including any two of the input: terminal, the output terminal, and the reference terminal of the phase displacement circuit.

Next, the operation in Embodiment 7 with the above configuration will be described. The phase difference between the terminal T51i and the terminal T52i is expressed by the following formula.

$$tan θ = \frac{ω τ}{1 + \frac{{Z}_{fi}}{{R}_{si} {A}_{oi}} [ 1 + {( ω τ )}^{2} ]} \qquad ( 4 )$$

The denominator of Mathematical Formula (4) indicates that the dependence of the time constant τ can be optionally set through selection of the feedback impedance value zfi, the impedance value Rsi of the impedance element 57i, and the amplification-attenuation rate A0i. Then, zfi, Rsi, and A0i in the denominator can be selected and set to be integer multiples, for example, for ANT1, . . . , ANTi, . . . , ANTn, for example. In this case, τ in Mathematical Formula (4) is made variable, thereby providing such a characteristic that the phases of the plurality of related phase displacement circuits 50i are variable in conjunction with each other in proportion to integer ratios of τ.

In the setting of the time constant τ relative to the frequency ω, this value may be selected to be a somewhat smaller value. In this way, the influence of the term (ωτ)² is rapidly reduced. Even when this value is equivalent or greater, the frequency ω utilized is mostly within a relatively narrow range. Hence, even in these practical situations, the above advantageous effect can be expected.

There is a characteristic that the above advantageous effect can similarly achieved even when peripheral impedances connected to the terminal T51i and the terminal T52i of the phase displacement circuit 50i are optionally given. Also, the phase displacement circuit 50i can achieve a similar advantageous effect even when a plurality of the phase displacement circuits 50i are connected in a cascade configuration or connected in a cascade configuration with the input and the output inverted.

To make the beams of the antennas independently variable in two-dimensional directions of an X-axis direction and a Y-axis direction, for example, the phase displacement circuit 50i for the X-axis direction may be equipped with an antenna for the X-axis direction while a phase shift circuit 50j for the Y-axis direction may be equipped with an antenna for the Y-axis direction, and the two phase displacement circuits 50i and 50j may be gang-controlled independently of each other. By associating these independent controls with each other, beams can be variable in any directions on the X-Y plane.

The phase displacement circuit 50i is a bidirectional function circuit. That is, the phase displacement circuit 50i is characterized in that it functions as a phase displacement circuit regardless of which one of the terminal 51i and the terminal 52i serves as an input terminal and the other as an output terminal. Further, since the phase displacement circuit 50i is a bidirectional circuit, it can be incorporated as a constituent circuit of circuit for use in both transmission and reception by properly performing impedance matching between the terminal 51i and the terminal 52i.

By us in the distribution-type transfer-function copying circuit 100 in the variable-radiation-direction antenna circuit 500, it is possible to reduce the number of reactance components used in the plurality of phase displacement circuits that, upon increase or decrease in phase, cause phase displacement in conjunction with each other in the same direction as the increase or the decrease. Thus, the circuit can be simplified. Moreover, when the amounts of a plurality of phase displacements are gang-controlled, the accuracy of the phase difference can be managed accurately and simply.

The variable-radiation-direction antenna circuit 500, which is shown in Embodiment 7, has been described based on the instance where there are n antennas and a single transmission-reception circuit. However, there may be a plurality of transmission-reception circuits. That is, the variable-radiation-direction antenna circuit 500 may have an MIMO (Multiple Input Multiple Output) configuration.

The above description has presented the instance where the distribution-type transfer-function copying circuit 100 is utilized in the variable-radiation-direction antenna circuit 500. However, the distribution-type transfer-function copying circuit 100 can be utilized in circuits other than the variable-radiation-direction antenna circuit 500. Specifically, the distribution-type transfer-function copying circuit 100 can be utilized in circuits in which a series of similar circuits such as impedance matching circuits, demultiplexing circuits, multiplexing circuits, or variable-antenna-electrical-length circuits is provided. Moreover, the number of reactance elements can be reduced, and therefore the number of external components for LSI can be reduced.

### EXPLANATION OF THE REFERENCE NUMERALS

1 transfer-function copying circuit
T2 first input terminal
T3 second input terminal
T4 output terminal
5 reference-signal generation circuit
6 coefficient-signal synthesis circuit
7 transfer-signal production circuit
8 transfer-signal relay circuit
9 transfer-signal synthesis circuit
T20 first reference-signal terminal
T21 coefficient signal terminal
T22 relayed signal terminal
T24 second-reference-signal terminal
T25 transfer signal terminal
100 distribution-type transfer-function copying circuit
200 reference-signal distribution circuit
300 relayed-signal distribution circuit

1. A transfer-function copying circuit comprising:
a reference-signal generation circuit that generates a first reference signal and a second reference signal proportional to a first input signal based on the first input signal and outputs the resulting first reference signal and the resulting second reference signal, which is proportional to the first input signal;
a coefficient-signal synthesis circuit that divides a second input signal containing at least a frequency component contained in the first input signal by the first reference signal or multiplies the second input signal and the first reference signal, and outputs a resulting coefficient signal;
a transfer-signal production circuit that performs a desired frequency-selection control process on the second reference signal and outputs a resulting transfer signal; and
a transfer-signal synthesis circuit that performs a transfer-signal synthesis process involving multiplying the coefficient signal and the transfer signal and outputs a resulting signal to an output terminal.

2. The transfer-function copying circuit according to claim 1, wherein
the reference-signal generation circuit includes
a signal distribution circuit that performs a signal distribution process on the first input signal to output a first output signal to a first output terminal and output the second reference signal to a second output terminal, and
a division circuit that performs a division process to divide a reference signal by the first output signal fed from the first output terminal of the signal distribution circuit, and outputs a resulting quotient signal as the first reference signal, and
the coefficient-signal synthesis circuit includes
a multiplication circuit that performs a multiplication process on the second input signal and the first reference signal and outputs a resulting signal, and
a low-pass filter circuit that performs a low-pass filter process on the signal fed from the multiplication circuit, and outputs a resulting coefficient signal to the transfer-signal synthesis circuit.

3. A transfer-function copying circuit comprising:
a reference-signal generation circuit including a signal-amplitude standardization circuit that performs a standardization process to make amplitude of a first input signal equal to a value of signal amplitude of a reference signal, and outputs a resulting output signal, a signal distribution circuit that performs a signal distribution process on the output signal fed from the signal-amplitude standardization circuit, to output a first output signal to a first output terminal and output a second reference signal to a second output terminal, and a conjugate-signal generation circuit that performs a process of generating a signal containing, as mutually orthogonal components thereof, one of two mutually orthogonal components of the first output signal, fed from the signal distribution circuit, and a component obtained by inverting a sign of the other of the two mutually orthogonal components of the first output signal, and outputs the generated signal as a first reference signal;
a coefficient-signal synthesis circuit that divides a second input signal containing at least a frequency component contained in the first input signal by the first reference signal or multiplies the second input signal and the first reference signal, and outputs a resulting coefficient signal;
a transfer-signal production circuit that performs a desired frequency-selection control process on the second reference signal and outputs a resulting transfer signal; and
a transfer-signal synthesis circuit that performs a transfer-signal synthesis process involving multiplying the coefficient signal and the transfer signal and outputs a resulting signal to an output terminal.

4. The transfer-function copying circuit according to any one of claim 1, further comprising
a transfer-signal relay circuit that relays the transfer signal from the transfer-signal production circuit to the transfer-signal synthesis circuit, wherein
the reference-signal generation circuit includes a first orthogonal distribution circuit that performs an orthogonal distribution process on the first reference signal to output two mutually orthogonal signals to the coefficient-signal synthesis circuit,
the coefficient-signal synthesis circuit performs the coefficient-signal synthesis process on the two mutually orthogonal signals from the first orthogonal distribution circuit and two signals distributed from the second input signal, and feeds resulting two of the coefficient signals to the transfer-signal synthesis circuit, and
the transfer-signal relay circuit includes a second orthogonal distribution circuit that performs an orthogonal distribution process on the transfer signal from the transfer-signal production circuit to relay two mutually orthogonal signals to the transfer-signal synthesis circuit.

5. The transfer-function copying circuit according to claim 4, wherein the first orthogonal distribution circuit performs an orthogonal distribution process on a signal into a first reference A signal and a first reference B signal, the signal being the first input signal made proportional to the reference signal,
the coefficient-signal synthesis circuit includes
a first multiplication circuit that performs a multiplication process on the second input signal and the first reference A signal to obtain a coefficient A signal, and
a second multiplication circuit that performs a multiplication process on the second input signal and the first reference B signal to obtain a coefficient B signal,
the second orthogonal distribution circuit performs an orthogonal distribution process on the transfer signal from the transfer-signal production circuit to obtain a mutually orthogonal relayed A signal and relayed B signal, and
the transfer-signal synthesis circuit includes
a third multiplication circuit that performs a multiplication process on the coefficient A signal and the relayed A signal to obtain a first signal,
a fourth multiplication circuit that performs a multiplication process on the coefficient B signal and the relayed B signal to obtain a second signal, and
a first signal-addition-subtraction circuit that performs an addition process or a subtraction process on the first signal and the second signal and outputs a resulting signal to the output terminal.

6. The transfer-function copying circuit according to claim 1, wherein the coefficient-signal synthesis circuit includes:
a third orthogonal distribution circuit that performs an orthogonal distribution process on the second input signal to distribute and output a mutually orthogonal second input A signal and second input B signal, a fifth multiplication circuit that performs a multiplication process on one of a mutually orthogonal first reference A signal and first reference B signal and one of the second input A signal and the second input B signal to obtain an AA product signal,
a sixth multiplication circuit that performs a multiplication process on the other of the first reference A signal and the first reference B signal and the other of the second input A signal and the second input B signal to obtain a BB product signal,
a second signal-addition-subtraction circuit that performs an addition process or a subtraction process on the AA product signal and the BB product signal and outputs a resulting coefficient signal,
a seventh multiplication circuit that performs a multiplication process on the one of the first reference A signal and the first reference B signal and the other of the mutually orthogonal second input A signal and second input B signal to obtain an AB product signal,
an eighth multiplication circuit that performs a multiplication process on the other of the first reference A signal and the first reference B signal and the one of the second input A signal and the second input B signal to obtain a BA product signal, and
a third signal-addition-subtraction circuit that performs an addition process or a subtraction process on the AB product signal and the BA product signal and outputs a resulting coefficient signal.

7. The transfer-function copying circuit according to claim 1, wherein
a plurality of the coefficient-signal synthesis circuits and a plurality of the transfer-signal synthesis circuits are provided, and
the transfer-function copying circuit further comprises:
a reference-signal distribution circuit that distributes and feeds the signal from the reference-signal generation circuit to the plurality of coefficient-signal synthesis circuits; and
a relayed-signal distribution circuit that distributes and feeds the signal from the transfer-signal relay circuit to the plurality of transfer-signal synthesis circuits.

8. The transfer-function copying circuit according to claim 1, further comprising:
an analog-digital conversion circuit that converts analog signals fed to at least two input terminals into digital signals; and
a digital-analog conversion circuit that converts the digital signals, which are converted by the analog-digital conversion circuit, into an analog signal.

9. A gang-controlled phase displacement circuit comprising a variable-radiation-direction antenna circuit including
a plurality of antennas,
a plurality of phase displacement circuits provided respectively for the plurality of antennas, and
a coupling circuit coupling the plurality of antennas and the plurality of phase displacement circuits to any one of a transmission circuit, a reception circuit, and a transmission-reception circuit, wherein
each of the plurality of phase displacement circuits includes
the transfer-function copying circuit according to any one of claims 1 to 8, and
the second input terminal and the output terminal of the transfer-function copying circuit and a variable amplification-attenuation circuit including an amplification-attenuation-gain control terminal, on a current path including any two of an input terminal, an output terminal, and a reference terminal of the phase displacement circuit.

10. The transfer-function copying circuit according to claim 3, further comprising
a transfer-signal relay circuit that relays the transfer signal from the transfer-signal production circuit to the transfer-signal synthesis circuit, wherein
the reference-signal generation circuit includes a first orthogonal distribution circuit that performs an orthogonal distribution process on the first reference signal to output two mutually orthogonal signals to the coefficient-signal synthesis circuit,
the coefficient-signal synthesis circuit performs the coefficient-signal synthesis process on the two mutually orthogonal signals from the first orthogonal distribution circuit and two signals distributed from the second input signal, and feeds resulting two of the coefficient signals to the transfer-signal synthesis circuit, and
the transfer-signal relay circuit includes a second orthogonal distribution circuit that performs an orthogonal distribution process on the transfer signal from the transfer-signal production circuit to relay two mutually orthogonal signals to the transfer-signal synthesis circuit.

11. The transfer-function copying circuit according to claim 10, wherein
the first orthogonal distribution circuit performs an orthogonal distribution process on a signal into a first reference A signal and a first reference B signal, the signal being the first input signal made proportional to the reference signal,
the coefficient-signal synthesis circuit includes
a first multiplication circuit that performs a multiplication process on the second input signal and the first reference A signal to obtain a coefficient A signal, and
a second multiplication circuit that performs a multiplication process on the second input signal and the first reference B signal to obtain a coefficient B signal,
the second orthogonal distribution circuit performs an orthogonal distribution process on the transfer signal from the transfer-signal production circuit to obtain a mutually orthogonal relayed A signal and relayed B signal, and
the transfer-signal synthesis circuit includes
a third multiplication circuit that performs a multiplication process on the coefficient A signal and the relayed A signal to obtain a first signal,
a fourth multiplication circuit that performs a multiplication process on the coefficient B signal and the relayed B signal to obtain a second signal, and
a first signal-addition-subtraction circuit that performs an addition process or a subtraction process on the first signal and the second signal and outputs a resulting signal to the output terminal.

12. The transfer-function copying circuit according to claim 3, wherein the coefficient-signal synthesis circuit includes:
a third orthogonal distribution circuit that performs an orthogonal distribution process on the second input signal to distribute and output a mutually orthogonal second input A signal and second input B signal,
a fifth multiplication circuit that performs a multiplication process on one of a mutually orthogonal first reference A signal and first reference B signal and one of the second input A signal and the second input B signal to obtain an AA product signal,
a sixth multiplication circuit that performs a multiplication process on the other of the first reference A signal and the first reference B signal and the other of the second input A signal and the second input B signal to obtain a BB product signal,
a second signal-addition-subtraction circuit that performs an addition process or a subtraction process on the AA product signal and the BB product signal and outputs a resulting coefficient signal,
a seventh multiplication circuit that performs a multiplication process on the one of the first reference A signal and the first reference B signal and the other of the mutually orthogonal second input A signal and second input B signal to obtain an AB product signal,
an eighth multiplication circuit that performs a multiplication process on the other of the first reference A signal and the first reference B signal and the one of the second input A signal and the second input B signal to obtain a BA product signal, and
a third signal-addition-subtraction circuit that performs an addition process or a subtraction process on the AB product signal and the BA product signal and outputs a resulting coefficient signal.

13. The transfer-function copying circuit according to claim 3, wherein
a plurality of the coefficient-signal synthesis circuits and a plurality of the transfer-signal synthesis circuits are provided, and
the transfer-function copying circuit further comprises:
a reference-signal distribution circuit that distributes and feeds the signal from the reference-signal generation circuit to the plurality of coefficient-signal synthesis circuits; and
a relayed-signal distribution circuit that distributes and feeds the signal from the transfer-signal relay circuit to the plurality of transfer-signal synthesis circuits.

14. The transfer-function copying circuit according to claim 3, further comprising:
an analog-digital conversion circuit that converts analog signals fed to at least two input terminals into digital signals; and
a digital-analog conversion circuit that converts the digital signals, which are converted by the analog-digital conversion circuit, into an analog signal.
